(19) United States
(12) Patent Application Publication
(10) Pub. No.: US 2019/0145854 A1
(43) Pub. Date: May 16, 2019

(54) POWDER BLEND SEGREGATION TESTING APPARATUS AND METHOD

(71) Applicant: Sanyasi R. Kalidindi, Monroe, NJ (US)

(72) Inventor: Sanyasi R. Kalidindi, Monroe, NJ (US)

(21) Appl. No.: 15/813,699

(22) Filed: Nov. 15, 2017

(51) Int. Cl. G01M 7/02; G01N 1/20

(52) U.S. Cl. CPC G01M 7/025; G01N 1/2035; G01N 2033/0091; G01N 2203/0284; G01N 2001/205; G01M 7/022

(57) ABSTRACT

A number of membranes are mounted in a column, each membrane being at an angle to horizontal, with alternating angles to form a cascading progression for testing segregation of a powder blend. The membranes are each supported on cylindrical segments that are assembled into a column, and the column is mounted in a housing with a vibrator. With the vibrator actuated, the powder blend flows down the membranes and free falls into a collecting cup at the bottom. Tablets are formed of the segregated powder blend and analyzed for component uniformity.

### FIELD OF THE INVENTION

The present invention relates to the field of laboratory apparatus and methods, and more particularly to apparatus for testing of powder blends for segregation of the components.

### BACKGROUND OF THE INVENTION

Many pharmaceutical, food, cosmetic, and chemical products are made by blending different powders that are then compressed into tablets or packaged in unit dose capsules, bottles, etc. Although the powder blend may have an acceptable level of component uniformity, further processing, e.g. auger feeding, vibration feeding, screw feeding, vacuum transfer, etc. may cause a degree of segregation of the components that affects dosage uniformity. If one of the ingredients in a powder drink mix, for example, is an artificial sweetener, drinks made from different pouches of such a mix in which components are not uniform will taste differently. Similarly, if a pharmaceutical powder blend is not uniform, the resulting dosage form may be ineffective or dangerous. Another example is a disintegrant, used in solid pharmaceutical dosage forms (tablets and capsules, for example) typically at a level of 2-4% to help the dosage form disintegrate when it comes in contact with stomach fluids. A disintegrant is a critical component in a solid dosage formulation to ensure proper disintegration and dissolution. If a powder blend includes a disintegrant that has become partially segregated, some tablets/capsules may fail the dissolution specification. Ideally, powder blends should be tested for potential segregation problems at the formulation development stage. Once the product is being manufactured on a production scale, segregation problems are very difficult to correct because of regulatory or economic constraints. However, at the formulation development stage, laboratory batch sizes are small and the processing times are typically too short for a segregation problem to be detected with presently known techniques.

An Apparatus And Method For Testing Powder Properties is disclosed in U.S. Pat. No. 5,583,304 to the present inventor. The apparatus disclosed is mounted within a three-compartment housing that has a hopper connected to a programmable vibrator to simulate production conditions. There are certain problems with this apparatus, for example: (a) powder segregation does not occur when a static powder bed is subjected to vibration; (b) the flow of the powder from the hopper is impeded because the powder path width reduces from the hopper stem to the funnel die stem; (c) the flow of the powder is also hampered by a butterfly valve in the stem of the hopper; and (d) reproducibility is unreliable because the vibration device is mounted to the wall of the enclosure at a location remote from the hopper.

Another invention by the present inventor, disclosed in U.S. Pat. No. 7,204,164, is an improvement over the apparatus of U.S. Pat. No. 5,583,304 by (a) altering the geometry of the hopper stem to improve powder flow; (b) incorporating a new gate system to control the powder flow; (c) providing a technique for taking multiple unit-dose samples of the powder at predetermined intervals during testing; (d) directly linking the vibration device to the hopper for maximum vibration transmission, (e) assuring that the vibration intensity is reproducible; and (f) providing an apparatus for studying segregation potential, testing particle size distribution and flow rates of powders, resulting in a versatile apparatus. The apparatus of U.S. Pat. No. 7,204,164, though much better in design than the apparatus of U.S. Pat. No. 5,583,304, still has several drawbacks.

U.S. patent application Ser. No. 14/328,907, filed by the same inventor, describes an accelerated powder segregation apparatus and method that utilizes an ascending spiral channel which is connected to a vibration device. A powder sample is placed at the bottom of the ascending channel and subjected to vibration which causes the powder to travel upwards on the spiral channel. The particles of different components tend to travel at different speeds and segregate along the spiral channel. When the powder exits after traversing the spiral channel, it fills a number of cavities in a split sampling die for compaction into tablets and analysis for content uniformity. Although this apparatus and method is effective with a small sample, such as 10 g, there are two disadvantages: (a) each type of powder or powder blend travels at a different speed on the spiral channel depending on its flow characteristics, bulk density, particle size and particle morphology, which means each type of powder or powder blend is subjected to vibration for different time periods; and (b) the testing time cannot be controlled because one can collect the powder only when it exits the spiral channel.

A further apparatus and method for powder blend segregation testing is described in U.S. patent application Ser. No. 14/744,649 to the present inventor. This invention involves placing a powder blend sample on a membrane that is vibrated to cause segregation of powder components. The segregated components are transferred to a split die and compressed into tablets for uniformity analysis. It has been determined that this invention, while functionally operational, is limited to segregation simply based on vibration in a horizontal plane.

Besides vibration, there are other factors that may cause powder blend segregation such as flow of the material and free fall of the material as may happen when a powder blend is discharged from a blender or a bin. Thus, there is a need for a simple, practical and economical apparatus and method to perform powder blend segregation testing which requires only a small sample, and which subjects any type of powder blend to vibration, flow, and free fall, allowing different formulations to be compared under the same conditions. The invention disclosed herein provides such an apparatus and method.

### SUMMARY OF THE INVENTION

The present invention provides a powder blend segregation testing apparatus and method to determine the effect multiple factors of vibration, flow, and free fall have on segregation of the active and the critical inactive components of the blend. The apparatus is formed of a series of cylindrical segments some of which support a semi-rigid membrane at an angle to horizontal. Each membrane is angled in opposition to the adjacent membranes. Each of the membranes is cut to provide an opening at the lower end thereof, each of the openings being opposed to openings in adjacent membranes. The several cylindrical segments and the several membranes are assembled into a vertical column with the angles of the membranes opposed to one another as noted above, and the assembly is mounted in a housing having a vibration device connected thereto. A charge of powder blend is placed on the uppermost membrane and the vibration device is activated, causing the assembled series of cylindrical segments and membranes to be vibrated. The vibration causes the powder blend to move down the several membranes in sequence. During the powder blend movement under vibration and free fall after the last membrane, the powder blend may segregate according to the physical characteristics of the individual powder components.

### BRIEF DESCRIPTION OF THE DRAWINGS

FIG. 1 is a front elevation view of the powder blend segregation testing apparatus of the invention mounted in a housing.

FIG. 2 is an exploded front elevation view of the powder blend segregation testing apparatus of the invention.

FIG. 3 is a top plan view of one of the cylindrical segments of the apparatus seen in the direction indicated by line 3-3 of FIG. 2.

FIG. 4 is a cross sectional view of the one cylindrical segments seen in the direction indicated by line 4-4 of FIG. 3.

FIG. 5 is a front perspective view of a collecting cup of the invention, the cup containing a quantity of segregated powder blend, with a split tablet forming die positioned for being placed in the cup.

FIG. 6 is a front perspective view of the split tablet forming die after being filled with segregated powder blend and being inverted, a tool positioned adjacent to the die for removing excess powder from the top surface thereof.

FIG. 7 is a front perspective view of the split tablet forming die with excess powder removed from the surface and with a punch positioned for compacting powder into tablets.

### DETAILED DESCRIPTION OF THE INVENTION

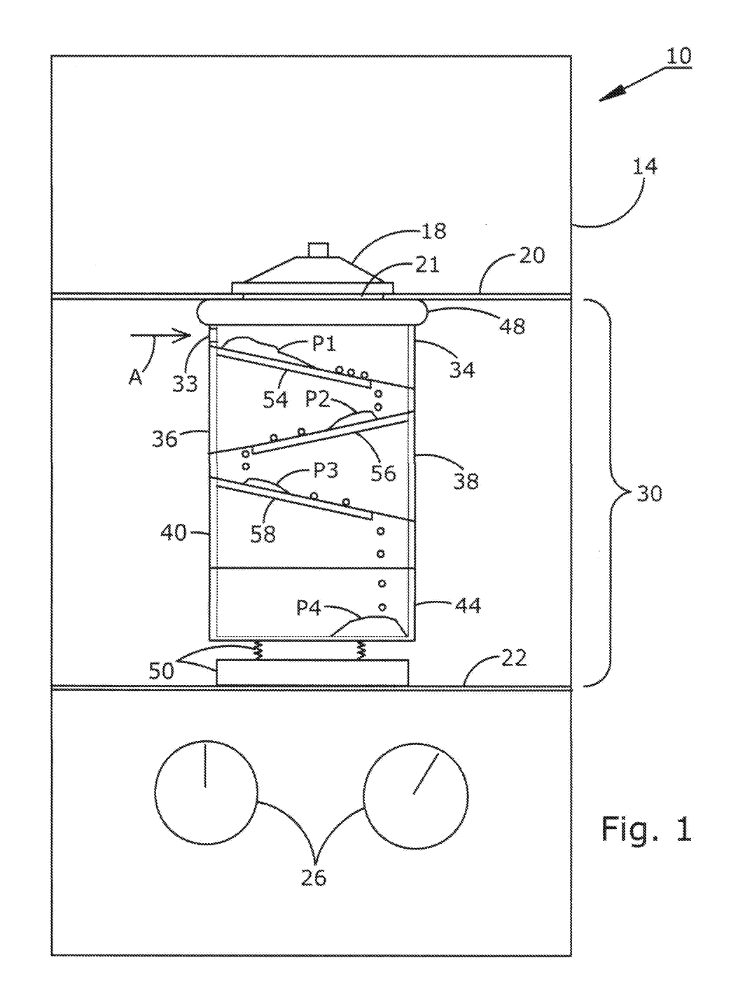

Referring to FIG. 1, the powder blend segregation testing apparatus 10 of the invention is shown in front elevation view. A housing 14 is configured for supporting a segregation column 30 between a plate 20 and a platform 22. Housing 14 is formed of a relatively stiff, dense material, e.g. 316 stainless steel. As illustrated, plate 20 and platform 22 are oriented in parallel, substantially horizontal, planes. Plate 20 is formed with a central opening 21 that is sized to support a vibrator 18 above segregation column 30. Platform 22 is preferably formed without any openings. Vibrator 18 may be any of various types of vibrator, preferably a low frequency audio speaker, commonly known as a woofer. Vibrator 18 is fixedly mounted to plate 20 and oriented to project vibrations downward at segregation column 30 when activated through controllers 26 provided to adjust amplitude and possibly frequency of vibration. A resilient base 50, including an array of springs or other resilient members, is adapted to securely support segregation column 30 within housing 14.

Referring further to FIG. 1, segregation column 30 is formed of a number of cylindrical segments that are configured to securely engage one another as will be described below. A charging segment 34 is positioned at the top of segregation column 30, charging segment 34 having a substantially horizontal upper periphery and a lower periphery being downwardly angled from left to right. Thus, charging segment 34 has a narrow side at the left as shown, and a wide side at the right as shown. A charging port 33 is formed at the narrow side of charging segment 34, therefore being close to the upper periphery of charging segment 34. Charging port 33 is configured to allow a quantity of powder P1 to be input at the upper portion of segregation column 30 by means of, e.g., a spoon or a funnel. Powder P1 is deposited on a first membrane 54 that is supported on a first segregation segment 36. First segregation segment 36 has an upper periphery that is angled downward from left to right to be in engagement with the angled lower periphery of charging segment 34. The lower periphery of first segregation segment 36 is oriented at a downward angle from right to left as illustrated. A second segregation segment 38 is located below first segregation segment 36, with an upper periphery of second segregation segment 38 angled downward from right to left as illustrated to be in engagement with the angled lower periphery of first segregation segment 36 and a lower periphery angled downward from left to right. A third segregation segment 40 is formed with an upper periphery angled downward from left to right as illustrated to be in engagement with the angled lower periphery of second segregation segment 38. The lower periphery of third segregation segment 40 is substantially horizontal and configured to securely engage a collecting cup 44 that has a substantially horizontal upper periphery and a substantially horizontal imperforate bottom surface, the bottom surface positioned on resilient base 50. A connective cap 48 is positioned on the upper end of charging segment 34. Connective cap 48 is formed with a cavity to receive the upper periphery of charging segment 34.

Referring further to FIG. 1, a first membrane 54 is supported at the top of first segregation segment 36 and is downwardly angled from left to right. A second membrane 56 is supported at the top of second segregation segment 38 and is downwardly angled from right to left. A third membrane 58 is supported at the top of third segregation segment 40 and is downwardly angled from left to right. Whereas the apparatus shown in FIG. 1 contains three segregation segments 36, 38, 40 and three membranes 54, 56, 58, other numbers of segregation segments and membranes are considered to be within the spirit and scope of the present invention. All components of segregation column 30 are formed of a substantially rigid and transparent material, e.g. acrylic resin. It will be noted that each of the membranes 54, 56, 58 terminates at a selected distance from the lower end of each respective segregation segment 36, 38, 40 leaving an opening to the next lower segment. Membranes 54, 56, 58 are formed of a substantially smooth surfaced, stiff material capable of movement in response to vibration, e.g. a 0.076 mm (0.003 inch) thick polyester polymer sheet. Different materials that conform to the operational requirements of the invention are considered within the scope of the invention.

Continuing with respect to FIG. 1, a charge of powder P1 is inserted as indicated by arrow A through charging port 33 to be deposited on an upper portion of first membrane 54. Vibrator 18 is activated at a selected amplitude and, optionally at a selected frequency of vibration. Vibrator 18 causes each membrane 54, 56, 58 to vibrate, the motion being transmitted to powder charge P1. Powder charge P1 begins to move in response to the vibration downward along the surface of first membrane 54. Due to the vibration and movement of powder P1, a degree of segregation causes certain of the components of the powder blend to move downhill at a faster speed than other components. Typically, components having a higher specific gravity move faster, reaching the lower terminus of first membrane 54. The particles are illustrated as round pellets that drop onto the upper portion of second membrane 56, and form a pile as powder portion P2. As the vibration from vibrator 18 continues, powder portion P2 further segregates and round pellets are seen dropping onto the upper portion of third membrane 58 to form powder portion P3. In the final phase of segregation, round pellets from powder portion P3 drop off third membrane 58 into collecting cup 44 as powder portion P4. At the end of the selected time period, vibrator 18 will deactivate and the previous quantities of powder represented as P1, P2, P3 will be accumulated in collecting cup 44 as powder portion P4 to be processed for uniformity analysis as described below.

Referring now to FIG. 2, segregation column 30 is shown in exploded front elevation view. Connective cap 48 resides at the top of segregation column 30 and extends laterally beyond the cylindrical diameter thereof. A vertically protruding ring 49 is formed on the upper surface of connective cap 48 with a diameter adapted for insertion into opening 21 through plate 20 (see FIG. 1). A central opening is formed through connective cap 48 to allow the propagation of vibratory waves to the apparatus below. Charging segment 34 with charging port 33 penetrating through an upper portion thereof is positioned below connective cap 48; a cover membrane 60 rests on top of charging segment 34 and vibrates when vibrator 18 is actuated, in turn vibrating the other membranes 54, 56, 58. Cover membrane 60 is formed of a similar sheet material as membranes 54, 56, 58. Cover membrane 60 helps to contain the powder dust that is typically generated during the process of vibrational segregation testing of powder blends and protects vibrator 18. First segregation segment 36 is positioned below charging segment 34 with first membrane 54 resting on first segregation segment 36. In sequence, second membrane 56, second segregation segment 38, third membrane 58, third segregation segment 40, and collection cup 44 complete the assembly of segregation column 30. Whereas segments 34, 36, 38, and 40 each have an open top and an open bottom, collection cup 44 is a closed bottom cup form. In the preferred embodiment of the invention, segregation column 30 is formed in circular cylindrical configuration. Alternate cylinder shapes, e.g. rectangular, are considered within the scope of the present invention. When the circular cylindrical components of the preferred embodiment are assembled, due in part to the angular, non-horizontal upper and lower peripheries shown being elliptical in shape, it is preferred to provide an alignment guide, e.g. a vertical set of marks or a series of keys and slots to assist in alignment. An alternate design of the present invention is to form the segregation column as a single piece with angularly oriented slots provided to support the several membranes.

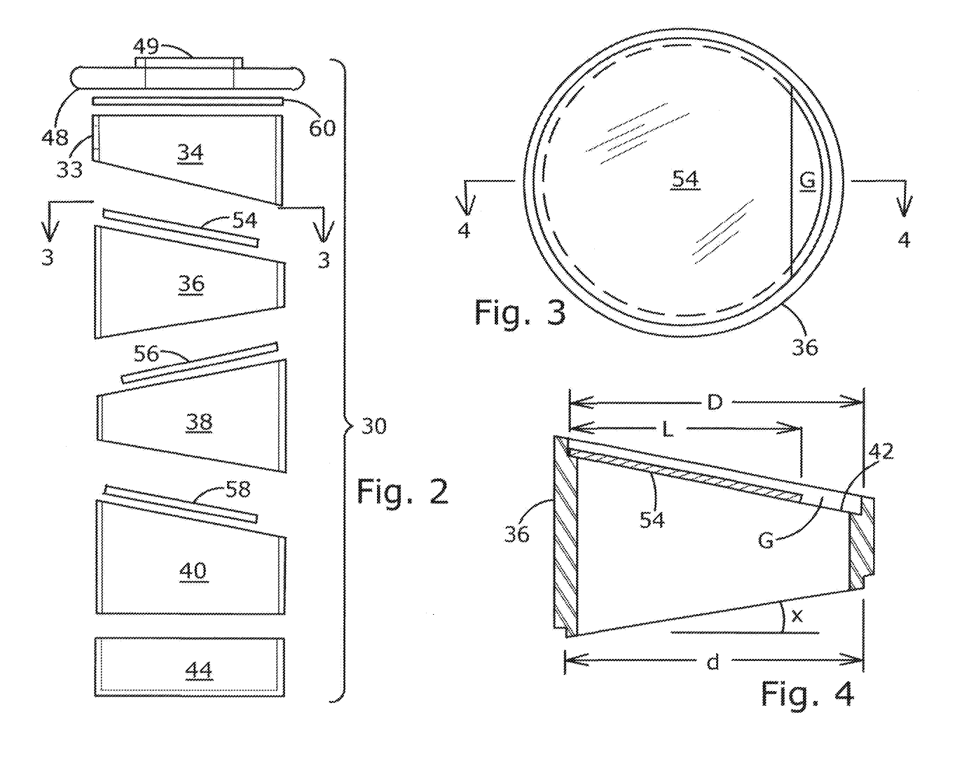

Referring now to FIG. 3, first membrane 54 and first segregation segment 36 are illustrated in top plan view in the direction indicated by line 3-3 of FIG. 2. First membrane 54 is supported on a lip formed at the top within first segregation segment 36. First membrane 54 is a truncated ellipse, leaving an opening G through which powder particles will pass during the segregation testing procedure performed according to the invention. Second and third membranes 56, 58 (see FIG. 2) are similarly formed.

Referring now to FIG. 4, first membrane 54 and first segregation segment 36 are illustrated in cross sectional view in the direction indicated by line 4-4 of FIG. 3. First segregation segment 36 is formed with an angle X between the lower periphery thereof and horizontal, angle X being between 5°-30°, and being preferably 10°. The upper periphery of first segregation segment 36 is formed at a reciprocal angle and so on to enable each of the segments to be assembled to form a substantially cylindrical column. The upper periphery of first segregation segment 36 is formed with a depression forming a lip 42, the lip 42 serving two purposes. As shown, first membrane 54 fits into and is supported by the formed lip 42. In addition, the lip 42 of the upper periphery of first segregation segment provides a supporting base for an opposite shape formed on the lower periphery thereof. The inside diameter D of the upper periphery of first segregation segment 36 is slightly larger than the outside diameter d of the lower periphery thereof to enable a sliding fit of higher and lower segments forming the cylindrical column. First membrane 54 is truncated to a dimension L, on the order of 65% to 85% of diameter D. Dimension L may be modified to accommodate the characteristics of different powder blends. A specific dimension L that has performed well in the present invention is 75% of diameter D. Each of the membranes 56 and 58 shown in FIGS. 1 and 2 are similarly truncated.

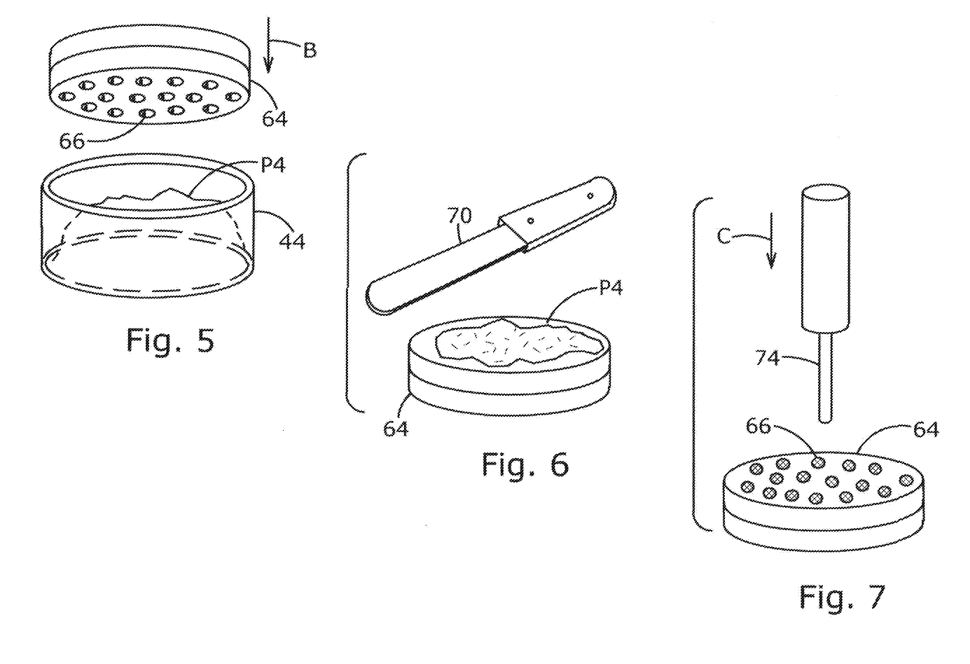

Referring now to FIG. 5, collection cup 44 is shown in front perspective view with segregated powder blend P4 contained therein. A split die 64 for producing compacted powder blend tablets is shown in position for being inserted into collecting cup 44 in the direction indicated by arrow B. Split die 64 is formed with a plurality of cavities 66 for receiving a quantity of powder P4, the cavities positioned on the lower surface of split die 64. Before placing split die 64 into collecting cup 44 on top of powder P4, collecting cup 44 is tipped gently from side to side to distribute powder P4 more uniformly. It is believed to be beneficial to the accurate analysis of powder blend segregation to form powder P4 into tablets for uniform sample size, integrity and control of the samples, as opposed to attempting to handle loose powder. Alternately, split tablet die 64 may be placed immediately below third segment 40 (see FIG. 2) with cavities 66 facing upward, and without collection cup 44.

Referring now to FIG. 6, split die 64 is shown after having been pressed down into powder P4 and subsequently inverted to orient the cavities 66 (see FIG. 5) with their open ends facing upward. Due to the inversion, an excess of powder P4 covers the upper face of split die 64. In order to ensure a substantially equal quantity of powder in each cavity 66, and thus in each tablet to be formed, the excess powder P4 is removed from the surface of split die 64, e.g. with a tool such as a laboratory spatula 70.

Referring now to FIG. 7, split die 64 is shown with the open ends of cavities 66 facing upward, each cavity 66 being filled with powder. A single punch 74 is positioned above split die 64 to be brought downward in the direction indicated by arrow C to compress the powder in a cavity 66 into a compacted tablet. Alternately, a multiple punch assembly may be used to compress several or all powder samples in the die simultaneously. After compressing all of the powder samples into tablets, the bottom half of split die 64 is removed and the tablets from the upper segment of the split die ejected using the single punch or the multiple punch assembly. Finally, the formed tablets are subjected to laboratory analysis, e.g. spectrophotometric analysis, for content uniformity. Thus, several formulations may be tested and the content uniformity results compared to determine which formulation is most resistant to segregation. Such a segregation resistant formulation will be selected as the best for production.

While the description above discloses preferred embodiments of the present invention, it is contemplated that numerous variations and modifications of the invention are possible and are considered to be within the scope of the claims that follow.

What is claimed is:

1. Apparatus for testing segregation of powder blends, comprising:
a. a plurality of membranes supported in a vertical column, each membrane oriented at a downward angle, each subsequent membrane oriented at a downward angle that is opposite in slope to the angle of an immediately previous membrane;
b. a gap formed at a lower end of each membrane;
c. means for placing a quantity of a powder blend on an uppermost membrane;
d. a collector positioned below a lowest membrane of the plurality of membranes; and
e. a vibrator mounted adjacent to the membranes for causing the plurality of membranes to vibrate.

2. The apparatus described in claim 1, wherein the column comprises a plurality of vertically assembled cylindrical segments, each segment configured for engagement with adjacent segments.

3. The apparatus described in claim 1, wherein each membrane is formed of a substantially smooth surfaced, stiff material capable of movement in response to vibration.

4. The apparatus described in claim 1, wherein the plurality of membranes comprises three membranes.

5. The apparatus described in claim 1, wherein the column is a circular cylindrical column.

6. The apparatus described in claim 5, wherein the gap formed at a lower end of each membrane is between 15%-35% of a diameter of the column.

7. The apparatus described in claim 1, further comprising a cover membrane mounted on a top surface of the column.

8. The apparatus described in claim 1, wherein the downward angle of each membrane is between 5° and 30°.

9. The apparatus described in claim 8, wherein the downward angle of each membrane is 10°.

10. The apparatus described in claim 1, wherein the collector is a collector cup having a substantially horizontal imperforate bottom surface.

11. The apparatus described in claim 2, wherein the means for placing a quantity of a powder blend on an upper membrane comprises a charging port formed adjacent to an upper periphery of an uppermost segment of the column.

12. The apparatus described in claim 2, further comprising a housing configured for holding the plurality of cylindrical segments and the collector, the vibrator being mounted to the housing.

13. The apparatus described in claim 12, further comprising a connector cap configured for engaging an uppermost cylindrical segment of the column and configured for engaging an opening formed in the housing adjacent to the vibrator.

14. A method for testing a powder blend for segregation, comprising the steps of:
a. providing a plurality of downwardly angled membranes in a vertical column with each subsequent membrane oriented at an oppositely directed angle to an immediately previous membrane;
b. placing a quantity of a powder blend on an uppermost membrane in the column;
c. activating a vibrator to cause each membrane of the plurality of membranes to vibrate;
d. allowing the quantity of powder blend to travel downward on each of the membranes and drop from a lower end of each previous membrane to an upper end of each subsequent membrane; and
e. collecting the powder blend in a collector cup positioned below the lowermost membrane.

15. The method described in claim 14, further comprising the step of deactivating the vibrator after a selected period of time.

16. The method described in claim 14, further comprising the step of mounting a cover membrane on a top of the column.

17. The method described in claim 14, further comprising the step of placing a tablet forming die into the collector cup with cavities in the tablet die facing downward and pressing the segregated powder blend into the cavities.

18. The method described in claim 17, further comprising the step of inverting the tablet forming die.

19. The method described in claim 18, further comprising the step of compressing the segregated powder blend in each cavity to form a tablet and ejecting the tablet.
